(19) United States
(12) Patent Application Publication
(10) Pub. No.: US 2014/0349811 A1
(43) Pub. Date: Nov. 27, 2014

(54) VEHICLE DRIVING SYSTEM

(71) Applicant: AISIN AW CO., LTD., Anjo-shi, Aichi-ken (JP)

(72) Inventors: Shinya Ichikawa, Anjo (JP); Kazuyuki Noda, Anjo (JP); Kazuhito Enomoto, Anjo (JP); Takayoshi Yonezu, Nishio (JP)

(21) Appl. No.: 14/367,008

(22) PCT Filed: Feb. 27, 2013
(86) PCT No.: PCT/JP2013/055083

§ 371 Date: Jun. 19, 2014

(30) Foreign Application Priority Data
Feb. 27, 2012 (JP) 2012-040328

(51) Int. Cl. B60W 20/00; F16D 13/74; B60W 10/08; B60W 10/06; B60W 10/02

(52) U.S. Cl. CPC B60W 20/40; B60W 10/06; B60W 10/02; B60W 10/08; F16D 13/74
USPC 477/5; 477/83

(57) ABSTRACT

A vehicle driving system in which a clutch is disposed between an engine output member and an automatic transmission and the clutch is used as a start clutch that is slip-controlled when a vehicle starts. When a lubricant relay valve is switched to the communicating position, oil from the pressure-regulating oil passage is supplied to the clutch via the input port, the output port, and the clutch lubricant passage. When the lubricant relay valve is switched to the cutoff position, the oil from the pressure-regulating oil passage is supplied to the clutch via the orifice and the clutch lubricant passage, the feedback pressure of the feedback port is increased, the communication rate between the pressure-regulating port and the back-pressure port is increased, and the amount of lubricant supplied from the back-pressure oil passage to the lubrication portion of the automatic transmission is increased.

### TECHNICAL FIELD

The present invention relates to a vehicle driving system having an engine-disconnection (K0) clutch serving as a start clutch and an automatic transmission, and more particularly, to a supply of lubricant to the clutch and the automatic transmission, which is suitably used for a one-motor hybrid driving system.

### BACKGROUND ART

In recent years, a one-motor hybrid driving system has been invented in which an output shaft (member) of an internal combustion engine is connected to an input shaft (member) of an automatic transmission via a K0 clutch and a rotor of an electric motor (rotary electrical machine) is connected to the automatic transmission. With the hybrid driving system, a vehicle starts by a drive force of the electric motor, the K0 clutch is connected to start an engine at a predetermined low speed, and the vehicle runs while the automatic transmission is operated by a drive force of the engine. At this time, the electric motor outputs power to assist the drive force of the engine, or generates power or runs idle with the drive force of the engine or a vehicle inertial force.

When a state of charge (SOC) of a battery is not sufficient, the vehicle starts with the dynamic power of the internal combustion engine and the K0 clutch serves as a start clutch at this time. When the engine starts with the electric motor or the vehicle starts with the engine, the K0 clutch is slip-controlled so as to avoid shock due to rapid torque variation between the input side and the output side thereof.

On the other hand, an hydraulic controller in an automatic transmission having a torque converter (hydraulic power transmission apparatus) equipped with a lockup clutch has been proposed, in which a lockup clutch is switched on and off by a lockup relay valve using a secondary pressure from a secondary regulator valve as a source pressure, which includes a second lubricant supply passage that supplies a back pressure of the secondary regulator valve to a lubricant passage of the automatic transmission and supplies the secondary pressure to the lubricant passage of the automatic transmission, and which cuts off the second lubricant supply passage when the lockup clutch is switched on by the lockup relay valve (Patent Document 1).

In the hydraulic controller, an amount of oil ejected from an oil pump is small and the supply of lubricant to the lubricant passage due to the back pressure of the secondary regulator valve is not sufficient at a low rotation speed at which the vehicle starts or the like, but the secondary pressure supplies the lubricant to the lubricant passage via the second lubricant supply passage to secure lubricant of the automatic transmission when the lockup clutch is turned off, and the second lubricant supply passage is cut off to increase the secondary pressure and to permit engagement of the lockup clutch in a region in which the rotation speed of a drive source is relatively low when the lockup clutch is turned on.

### PRIOR ART DOCUMENT

### Patent Document

Patent Document 1: Japanese Patent Application Publication No. 2011-75061 (JP 2011-75061 A)

### SUMMARY OF THE INVENTION

### Problem to be Solved by the Invention

The K0 clutch in the hybrid driving system requires a sufficient amount of lubricant so as to suppress generation of heat in slip control. Particularly, when the vehicle starts with the internal combustion engine, the slip control needs to be performed for a relatively long time so as to generate a creep torque before starting and it is preferable that the K0 clutch be immersed in the lubricant.

Since the slip control of the K0 clutch is performed at the time of starting and generating the creep torque before starting, the oil pump rotates at a low rate and a sufficient amount of lubricant cannot be secured only with the lubricant pressure due to the back pressure of the secondary regulator valve.

In Patent Document 1, even when the lockup clutch is used as a start (K0) clutch and the second lubricant supply passage can be used to lubricate the start (K0) clutch, the start clutch engages in a slip state at the time of starting and before starting and thus the secondary oil pressure cannot be actually supplied as the lubricant of the start clutch. Even when the secondary pressure can be supplied as the lubricant of the start clutch, the amount of lubricant supplied is small and it is difficult to lubricate the start clutch with a sufficient amount of lubricant and to cool the start (K0) clutch to prevent overheating.

Thus, an object of the present invention is to provide a vehicle driving system that solves the above-mentioned problems by switching a state where a regulated pressure from a regulator valve is directly supplied as lubricant of a clutch as a start clutch and a state where the regulated pressure is supplied via an orifice and supplying oil on a back pressure side of which a flow rate is accordingly regulated to a lubrication portion of an automatic transmission to efficiently distribute a finite amount of oil.

### Means for Solving the Problem

According to the present invention, there is provided a vehicle driving system (1) in which a clutch (6) is disposed between an engine output member (5a) and an automatic transmission (2) and the clutch (6) is used as a start clutch that is slip-controlled when a vehicle starts, vehicle driving system (1) including:

a regulator valve (23)(22) that has a pressure-regulating port (23a)(22a) and a feedback port (23c)(22c) communicating with a pressure-regulating oil passage (32)(31) from a source pressure (22f)(21) and a back-pressure port (23e)(22f) communicating with a back-pressure oil passage (45)(32) and that adjusts a communication rate between the pressure-regulating port and the back-pressure port to control an oil pressure of the pressure-regulating oil passage (32)(31);

a lubricant relay valve (25) that has an input port (25a) and an output port (25g) communicating with the pressure-regulating oil passage (32)(31) and that switches the input port and the output port to a communicating position or a cutoff position; and

a clutch lubricant passage (40) that communicates with the pressure-regulating oil passage (32)(31) via an orifice (39), that communicates with the output port (25g), and that supplies lubricant to the clutch (6),

wherein when the lubricant relay valve (25) is switched to the communicating position (ON position), oil from the pressure-regulating oil passage (32)(31) is supplied to the clutch (6) via the input port (25a), the output port (25g), and the clutch lubricant passage (40), a feedback pressure of the feedback port (23c)(22c) is decreased, the communication rate between the pressure-regulating port (23a)(22a) and the back-pressure port (23e)(22f) is decreased, and an amount of lubricant supplied from the back-pressure oil passage (45)(32) to a lubrication portion (47) of the automatic transmission (2) is decreased, and

wherein when the lubricant relay valve (25) is switched to the cutoff position (OFF position), the oil from the pressure-regulating oil passage (32)(31) is supplied to the clutch (6) via the orifice (39) and the clutch lubricant passage (40), the feedback pressure of the feedback port (23c)(22c) is increased, the communication rate between the pressure-regulating port (23a)(22a) and the back-pressure port (23e)(22f) is increased, and the amount of lubricant supplied from the back-pressure oil passage (45)(32) to the lubrication portion (47) of the automatic transmission (2) is increased.

For example, referring to FIG. 2, the regulator valve is a secondary regulator valve (23),

the pressure-regulating oil passage is a secondary-pressure oil passage (32) communicating with a secondary-pressure port (23a) which is a pressure-regulating port of the secondary regulator valve (23), and

the back-pressure oil passage is a lubricant passage (45) extending from the back-pressure port (23e) of the secondary regulator valve (23).

For example, referring to FIGS. 2 and 4, the lubricant relay valve (25) includes a second output port (25f) in addition to a first output port (25g) which is the output port, and

the second output port (25f) communicates with the clutch lubricant passage (40) via the orifice (39).

For example, referring to FIG. 3, the vehicle driving system further includes a communicating oil passage (40′) causing the pressure-regulating oil passage (32) and the clutch lubricant passage (40) to directly communicate with each other, and the orifice (39) is interposed in the communicating oil passage.

For example, referring to FIGS. 2 to 4, the vehicle driving system further includes a relief valve (41) that is branched from the clutch lubricant passage (40) and that releases a predetermined high pressure.

For example, referring to FIGS. 2 to 4, the clutch (6) is formed of a multi-disc wet clutch accommodated in a clutch chamber (30), lubricant from the clutch lubricant passage (40) is supplied to the clutch chamber via an in-port (30a) and the lubricant is discharged via an out-port (30b), and

an amount of oil discharged from the out-port is smaller than an amount of oil directly supplied via the output port (25g) of the lubricant relay valve (25) and is larger than an amount of oil supplied via the orifice (39).

For example, referring to FIG. 1, the vehicle driving system further includes a rotary electrical machine (3), a rotor (26) of the rotary electrical machine is connected to an input member (7) of the automatic transmission (2) and the vehicle driving system is a hybrid vehicle driving system (1), and

the clutch is a disconnection clutch (6) that connects or disconnects the rotor of the rotary electrical machine (3) and the engine output member (5a).

For example, referring to FIGS. 2 to 4, the lubricant relay valve (25) includes a modulator-pressure input port (25b) supplied with a modulator pressure obtained by decreasing the source pressure to a predetermined pressure, a third output port (25i) from which lubricant (43) is directly supplied to the rotary electrical machine (3), and a fourth output port (25h) that communicates with the rotary electrical machine (3) via an axial center oil passage (42) of the automatic transmission (2), and

the modulator-pressure input port (25b) communicates with the third output port (25i) when the lubricant relay valve (25) is switched to the communicating position (ON), and communicates with the fourth output port (25h) when the lubricant relay valve is switched to the cutoff position (OFF).

The reference symbols written in parentheses reflect what are in the drawings and the configurations described in the appended claims are not affected at all thereby.

### Effects of the Invention

According to claim 1, when the clutch is in a complete engagement state or a released state at the time of cruising of a vehicle or the like, the lubricant relay valve is switched to the cutoff position, oil is supplied to the clutch lubricant passage from the pressure-regulating oil passage via the orifice at a low flow rate, and lubricant is supplied to the lubrication portion of the automatic transmission from the back-pressure side of the regulator valve at a relatively high flow rate.

At the time of slip control of the clutch such as at the time of starting of the vehicle, the lubricant relay valve is switched to the communicating position, oil is directly supplied to the clutch lubricant passage from the pressure-regulating oil passage, the clutch in the slip state can be cooled with a sufficient amount of lubricant, the amount of oil supplied to the back-pressure port of the regulator valve accordingly decreases, and the amount of lubricant supplied to the lubrication portion of the automatic transmission decreases. However, in this state, the automatic transmission is in a stop state or at a very low rotation speed and thus the effect from lack of lubricant is small.

Accordingly, a finite amount of oil of an oil pressure source can be efficiently used as necessary, and it is thus possible to appropriately optimize and downsize an oil pump.

According to claim 2, when the regulator valve is a secondary regulator valve, it is possible to directly supply the secondary pressure to the clutch so as to appropriately lubricate the clutch at the time of slip control of the clutch, and it is also possible to secure an amount of oil supplied to the lubricant passage on the back-pressure side and so as to appropriately lubricate the automatic transmission at the time of non-slip state of the clutch such as complete engagement.

According to claim 3, since lubricant is supplied to the clutch lubricant passage from the second output port of the lubricant relay valve via the orifice, it is possible to easily and satisfactorily switch the amount of lubricant for the clutch.

According to claim 4, since oil is directly supplied to the clutch lubricant passage from the pressure-regulating oil passage via the orifice, it is possible to constantly secure a supply of a small amount of oil to the clutch via the orifice and thus to improve reliability.

According to claim 5, even when the regulator valve fails to be turned on and the supply pressure to the clutch lubricant passage becomes high, it is possible to prevent a problem of increasing a drag torque at the time of releasing the clutch by releasing the high pressure using the relief valve.

According to claim 6, since the clutch formed of the multi-disc wet clutch is accommodated in the clutch chamber and the amount of oil discharged from the clutch chamber is smaller than the amount of oil directly supplied from the output port of the lubricant relay valve and is larger than the amount of oil supplied via the orifice, oil is gathered in the clutch chamber, the clutch is slip-controlled in the immersed state, and it is thus possible to prevent an increase in temperature of the clutch. In the released state or the complete engagement state, oil is not gathered in the clutch chamber and it is thus possible to suppress generation of a drag torque.

According to claim 7, the vehicle driving system is applied to a hybrid vehicle driving system having a rotary electrical machine. In the normal state where a vehicle starts with the rotary electrical machine, an excessive amount of lubricant is not supplied to the clutch and it is possible to prevent energy loss. When the state of charge of the battery is not sufficient and the vehicle starts with the internal combustion engine, it is possible to supply a sufficient amount of lubricant to the clutch and to cause the vehicle to start while slip-controlling the clutch.

According to claim 8, in the slip control of the clutch when the vehicle starts with the internal combustion engine, lubricant from the modulator-pressure input port can be directly supplied to the rotary electrical machine while directly supplying a large amount of lubricant to the clutch, thereby appropriately cooling the rotary electrical machine even at a low rotation speed and with a high load. In the normal running in which the rotary electrical machine rotates along with the input shaft of the automatic transmission, lubricant can be appropriately supplied to the rotary electrical machine via the axial center oil passage, thereby reducing energy loss.

### BRIEF DESCRIPTION OF THE DRAWINGS

FIG. 1 is a schematic diagram illustrating a hybrid driving system to which the present invention can be applied.

FIG. 2 is a diagram illustrating a hydraulic circuit according to an embodiment of the present invention.

FIG. 3 is a diagram illustrating a hydraulic circuit according to a partially-modified embodiment.

FIG. 4 is a diagram illustrating a hydraulic circuit according to another embodiment.

### MODES FOR CARRYING OUT THE INVENTION

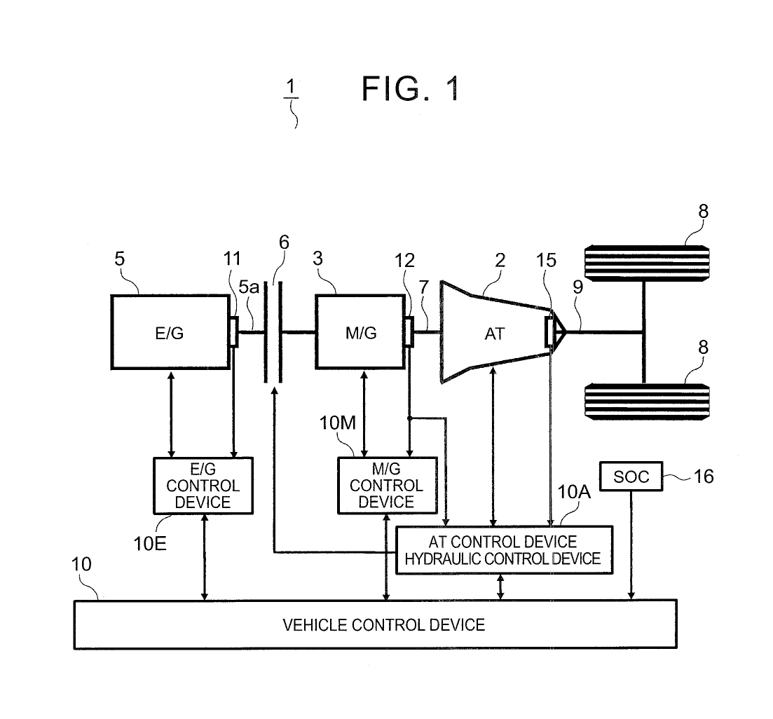

Hereinafter, embodiments of the present invention will be described with reference to the accompanying drawings. As illustrated in FIG. 1, a hybrid vehicle driving system 1 is of a so-called one-motor type including an automatic transmission 2, a rotary electrical machine (hereinafter, referred to as an electric motor) 3, and a disconnection clutch 6 (hereinafter, referred to as K0 clutch) disposed between a rotating portion (rotor) of the electric motor 3 and an output shaft 5a of an internal combustion engine 5. An input member (hereinafter, referred to as an input shaft) 7 of the automatic transmission 2 is connected to the rotating portion of the electric motor 3 and the output member (hereinafter, referred to as an output shaft) 9 thereof is connected to drive wheels 8. The internal combustion engine 5, the electric motor 3, and the automatic transmission 2 (including the K0 clutch 6) are controlled by an engine (E/G) control device 10E, a motor (M/G) control device 10M, and an automatic transmission and hydraulic (AT) control device 10A, respectively, and these control devices 10E, 10M, and 10A are comprehensively controlled by a vehicle control device 10. Signals from an engine rotation speed sensor 11, a rotation speed sensor 12 sensing rotation speeds of the electric motor and the input shaft 7 of the automatic transmission which rotate together, and an output shaft rotation sensor 15 are input to the control devices 10E, 10M, and 10A, respectively. A battery state of charge (SOC) signal 16 is input to the vehicle control device 10.

The electric motor (rotary electrical machine) 3 serves as a drive source converting electric energy into mechanical energy, a generator converting mechanical energy into electric energy, and a starter starting an engine. The automatic transmission 2 employs a multi-stage transmission of 6 forward speed steps and 1 reverse speed step or the like, but is not limited thereto and a continuously variable transmission such as a belt CVT, a cone-ring CVT, and a toroidal CVT may be employed. Here, the electric motor (rotary electrical machine) 3 may be used as only a drive source and another rotary electrical machine may be used as the generator and the engine starter.

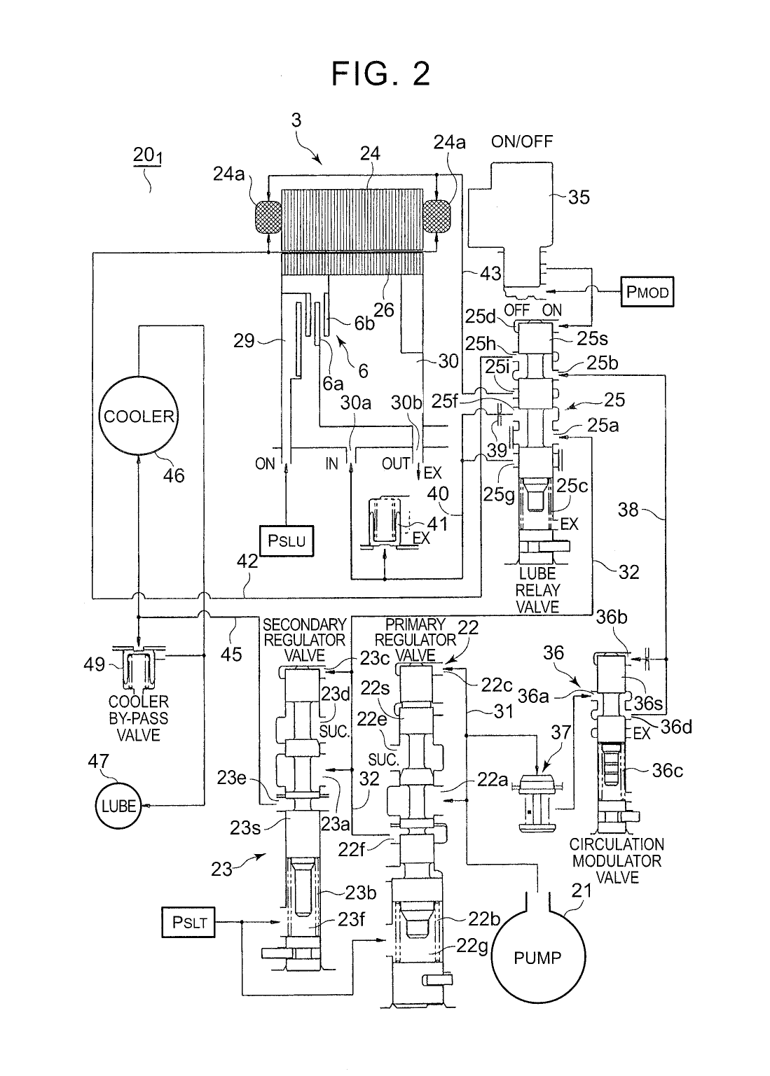

A hydraulic circuit as a lubricating device according to the present invention will be described below with reference to FIG. 2. A hydraulic circuit 20₁ includes an oil pump 21, a primary regulator valve 22, a secondary regulator valve 23, and a lubricant relay valve 25. The oil pump 21 may be a pump schematically illustrated as one pump generating an oil pressure with both of a mechanical pump driven with an engine output shaft 5a and an electric pump, or may be one pump driven with a faster one of the rotations of the engine output shaft 5a and the rotor of the electric motor 3. In either case, a predetermined oil pressure is generated regardless of whether the drive source of a vehicle is the electric motor 3 or the internal combustion engine 5.

The electric motor 3 schematically illustrated is constructed as a large-diameter hollow motor and includes a stator 24 fixed to a case and a rotor 26 connected as a unified body to the input shaft of the automatic transmission. The stator 24 is formed by winding a coil on an iron core and coil ends 24a protrude from both sides in the width direction of the iron core. A disconnection (K0) clutch 6 is disposed radially inside of the rotor 26. The K0 clutch 6 is formed of a wet multi-disc clutch, an inner friction plate 6a is connected to an engine output member, and an outer friction plate 6b thereof is connected to the rotor 26 of the electric motor 3 and the input shaft 7 of the automatic transmission 2. The engine output member is connected to an engine crank shaft via a torsion spring or the like, substantially rotates along with the engine output shaft, and is hereinafter referred to as an engine output shaft 5a.

The K0 clutch 6 is controlled to a release state, a slip control state, and a complete engagement state by the use of an oil pressure to a hydraulic servo 29, and a control pressure (P_{SLU}) from a linear solenoid valve is supplied to the hydraulic servo 29. The K0 clutch 6 is accommodated in a clutch chamber 30, and the clutch chamber 30 is supplied with lubricant from an in-port 30a and the lubricant passes through multi-disc friction plates 6a and 6b of the K0 clutch 6 and is discharged from an out-port 30b.

The primary regulator valve 22 includes a spool 22s biased with a spring 22b, and has a feedback port 22c, a line-pressure port 22a, a surplus-pressure port 22e, and a back-pressure port 22f at an end of the spool. An oil chamber 22g in which the spring 22b is disposed is supplied with a control pressure P_{SLT} from the linear solenoid valve controlled on the basis of a slot opening degree. The feedback port 22c and the line-pressure port 22a are supplied with oil from the oil pump 21 via a line-pressure oil passage 31, a spool 22s moves by the feedback pressure of the feedback port 22c and the control pressure of the oil chamber 22g, communication rates between: the line-pressure port 22a; and the surplus-pressure port 22e and the back-pressure port 22f, are adjusted, and the line-pressure port 22a is regulated to a line pressure corresponding to the slot opening degree. The surplus pressure from the surplus-pressure port 22e is returned to the oil pump 21 and the back pressure from the back-pressure port 22f communicates with the secondary-pressure oil passage (pressure-regulating oil passage) 32.

The secondary regulator valve 23 includes a spool 23s which is biased with a spring 23b, and includes, at one end of the spool, a feedback port 23c, a secondary-pressure port 23a, a surplus-pressure port 23d, a back-pressure port 23e, and an oil chamber 23f accommodating the spring 23b therein. The oil chamber 23f is supplied with a control pressure P_{SLT} from the linear solenoid valve controlled on the basis of the slot opening degree. Thus, the back pressure from the back-pressure port 22f of the primary regulator valve 22 is used as the source pressure, and the oil pressure of the secondary-pressure oil passage 32 is set as the secondary pressure by moving the spool 23s by the feedback pressure of the feedback port 23c and the control pressure of the oil chamber 23f to adjust the communication rate between: the secondary-pressure port 23a; and the surplus-pressure port 23d and the back-pressure port 23e. The surplus pressure of the surplus-pressure port 23d is returned to the oil pump 21 and the back pressure of the back-pressure port 23e is supplied as a lubricant pressure to the lubricant passage 45.

The lubricant relay valve 25 includes a spool 25s biased with a spring 25c and includes a control oil chamber 25d at one end of the spool, and the control oil chamber 25d is supplied with an oil pressure from a solenoid valve 35 for on-off switching. The lubricant relay valve 25 includes an input port 25a communicating with the secondary-pressure oil passage 32, an input port 25b supplied with a modulator pressure from a modulator valve 36, a first output port 25g, a second output port 25f, a third output port 25i, and a fourth output port 25h. The solenoid valve 35 outputs (ON) or cuts off (OFF) the modulator pressure P_{MOD} and guides the modulator pressure to the control oil chamber 25d to switch the lubricant relay valve 25. In the modulator valve 36, an input port 36a is supplied with a line pressure from the line-pressure oil passage 31 via a check valve 37 for backflow prevention, and a predetermined modulator pressure is output to a modulator oil passage 38 from the output port 36d by the feedback pressure of the feedback port 36b acting on an end of a spool 36s and a spring 36c acting on the other end.

The second output port 25f of the lubricant relay valve 25 communicates with the clutch lubricant passage 40 that leads to the in-port 30a of the clutch chamber 30 via the orifice 39. The first output port 25g communicates with the clutch lubricant passage 40 with the flow rate maintained without being reduced by the orifice. The lubricant passage 40 is branched and communicates with a relief valve 41 for releasing a high pressure equal to or more than a predetermined pressure. The amount of oil discharged from the out-port 30b of the clutch chamber 30 is set to be smaller than the amount of oil directly supplied from the first output port 25g and larger than the amount of oil supplied via the orifice 39.

The lubricant from the fourth output port 25h is supplied to the electric motor 3 via an axial center oil passage 42 formed in the input shaft 7. The lubricant from the third output port 25i is directly supplied to a stator 24 of the electric motor 3 via a direct oil passage 43 formed in a case or the like.

The lubricant passage 45 from the back-pressure port 23e of the secondary regulator valve 23 is guided to lubrication portion 47 of the automatic transmission 2 via an oil cooler 46. The lubricant passage 45 is branched and communicates with a cooler bypass valve 49 and surplus oil to a cooler 46 is directly guided to the lubrication portion 47.

The operations of the above-mentioned embodiment will be described below. The hybrid vehicle driving system 1 starts using the electric motor 3 as a drive source in a normal state where the battery state of charge (SOC) is not insufficient. That is, in a vehicle stop state where a shift lever is set to a D (drive) range and the automatic transmission 2 is set to a first speed, the electric motor 3 is in a creep state in which a creep torque is generated. When a driver depresses an accelerator pedal in this state, the electric motor 3 generates a torque corresponding to an accelerator operation amount. The torque of the electric motor 3 is transmitted to the drive wheels 10 via the automatic transmission 2 to cause the vehicle to start. At this time, the K0 clutch 6 is in a disconnected state. When the vehicle reaches a predetermined speed, the K0 clutch 6 is connected to start the internal combustion engine 5 with the torque of the electric motor 3. In the state where the engine 5 starts, the rotation of the engine output shaft 5a is transmitted to the drive wheels 10 via the automatic transmission 2 and the vehicle speed increases to a cruising speed by upshifting the automatic transmission 2. At this time, the electric motor 3 outputs power to assist the engine torque, or generates power (regenerates power) with the engine torque or the vehicle inertial force, or rotates without any load.

In the normal state, the solenoid valve 35 is maintained in the OFF state and the lubricant relay valve 25 is maintained in the illustrated state (OFF position) in which the spool 25s moves with the spring 25c. In this state, the secondary pressure of the oil passage 32 which is regulated by the secondary regulator valve 23 is output from the secondary-pressure input port 25a of the lubricant relay valve 25 to the second output port 25f. Then, the oil pressure from the second output port 25f is narrowed to be a small amount of oil by the orifice 39 and is guided from the clutch lubricant passage 40 to the clutch chamber 30 via the in-port 30a. Even when the K0 clutch 6 in the clutch chamber 30 is slip-controlled for a short time at the time of starting the internal combustion engine 5, the K0 clutch is substantially in the release state at the time of starting and is in the complete engagement state after starting of the engine. Accordingly, the amount of heat generated from the K0 clutch is small, the clutch is lubricated and cooled with the small amount of oil, and the lubricant in the clutch chamber 30 is discharged from the out-port 30b. At this time, the lubricant is not gathered in the clutch chamber 30 and the drag torque due to the oil can be suppressed to a satisfactorily small value in the release state of the clutch.

On the other hand, the line pressure of the line-pressure oil passage 31 is regulated to a predetermined pressure by the modulator valve 36 via the check valve 37, and is supplied to the modulator-pressure input port 25b of the lubricant relay valve 25 via the modulator oil passage 38. The input port 25b communicates with the fourth output port 25h as illustrated in the drawing and the lubricant is guided to the axial center oil passage 42. The lubricant from the axial center oil passage 42 is supplied to the electric motor 3 by the centrifugal force based on the rotation of the input shaft 7. The lubricant pressure from the back-pressure port 23e of the secondary regulator valve 23 is supplied to the lubrication portion 47 of the automatic transmission 2 via the lubricant passage 45 and the oil cooler 46.

When the battery state of charge (SOC) is insufficient, the hybrid driving system 1 starts using the internal combustion engine 5 as a drive source and the K0 clutch 6 serves as a start clutch at this time. The internal combustion engine 5 is in a rotating state, the shift lever is in the D range, and the automatic transmission 2 is in a first speed. In this state, when the driver is depressing a brake pedal, the K0 clutch 6 as the start clutch is in a disengagement (release) state, the solenoid valve 35 is at the OFF position, the lubricant relay valve 25 is in the illustrated state (OFF position), and a small amount of lubricant is supplied to the clutch chamber 30 from the second output port 25f via the orifice 39 as described above.

When the driver releases the depression of the brake pedal, the vehicle is in a start standby state and the start clutch 6 is slip-controlled. That is, an operation pressure supplied to the hydraulic servo 29 serves as a creep pressure and the start clutch 6 is slip-controlled to generate a creep torque. Then, the solenoid valve 35 is switched to the ON state, the ON pressure of the solenoid valve 35 is supplied to the control oil chamber 25d of the lubricant relay valve 25, and the lubricant relay valve 25 is switched to a state where the spool 25s thereof moves downward against the spring 25c (ON position). Accordingly, the secondary pressure from the secondary-pressure oil passage 32 is output from the input port 25a to the first output port 25g, and is guided to the in-port 30a of the clutch chamber 30 via the clutch lubricant passage 40 with the flow rate maintained. A large amount of lubricant guided to the in-port 30a is larger than the amount of lubricant discharged from the out-port 30b, the clutch chamber 30 is thus filled with the lubricant, and the clutch 6 is slip-controlled in a state where the multi-disc friction plates 6a and 6b are immersed in the lubricant. The start standby state is set to a state where the driver releases the depression of the brake pedal, but the present invention is not limited to this state and the start standby state may be set to another state such as a state where the shift lever is switched to the D range.

When the driver depresses the accelerator pedal in the creep state of the vehicle based on the creep pressure, the operating (supply) pressure increases with an accelerator operation amount (request torque), the start clutch 6 is slip-controlled to increase the torque capacity, and thus the vehicle starts. In the slip control of the start clutch 6, a large amount of lubricant is supplied, the multi-disc friction plates of the K0 clutch 6 are immersed in a sufficient amount of lubricant, and thus the generation of heat is suppressed. Particularly, when the driver slowly depresses the accelerator pedal and the time to the complete engagement extends, or when the creep state is maintained for a long time due to starting on an uphill road or the like and the slip-control time of the start (K0) clutch 6 extends, the K0 clutch 6 is immersed in a sufficient amount of lubricant and is prevented from rising to a high temperature.

On the other hand, since a large amount of oil is discharged from the first output port 25g while the K0 clutch 6 is slip-controlled, the oil pressure (secondary pressure) of the secondary-pressure oil passage 32 is kept low, the secondary regulator valve 23 has a small feedback pressure acting on the feedback port 23c thereof, and the spool 23s is close to the illustrated state based on the spring 23b. In this state, the communication of the secondary-pressure port 23a and the back-pressure port 23e is disconnected or the communication rate is small, and the amount of oil supplied to the lubricant passage 45 is 0 or is very small. That is, substantially the entire amount of oil on the secondary side from the back-pressure port 22f of the primary regulator valve 22 defined by the oil pump 21 is used to lubricate the K0 clutch 6 and the amount of lubricant supplied from the lubricant passage 45 to the lubrication portion 47 of the automatic transmission 2 is zero or very small. However, in the slip state of the K0 clutch 6, the rotation of the automatic transmission 2 is 0 or very slow in the creep torque state in start standby or at the time of starting. Accordingly, even when the supply of lubricant from the lubricant passage 45 is stopped for a short time, there is no problem.

By switching the lubricant relay valve 25 (to the ON position) in the slip control, the input port 25b from the modulator-pressure oil passage 38 communicates with the third output port 25i. The oil from the output port 25i is directly supplied to the stator 24 of the electric motor 3 from the oil passage 43. Accordingly, when the input shaft 7 of the automatic transmission 2 is stopped or rotates at a very low speed, the electric motor 3 is supplied with the lubricant from the modulator-pressure oil passage 38 and is cooled.

When the K0 clutch 6 as the start clutch completely engages, the output torque of the internal combustion engine 5 is directly transmitted to the input shaft 7 of the automatic transmission 2, the automatic transmission 2 is appropriately upshifted, and the vehicle runs at a cruising speed. At this time, since the battery state of charge is generally insufficient, the electric motor 3 serves as a generator and the battery is charged by the internal combustion engine.

When the K0 clutch 6 completely engages, the solenoid valve 35 is turned off and the lubricant relay valve 25 is switched to the illustrated state (OFF position). In this state, the secondary-pressure input port 25a communicates with the second output port 25f and a small amount of lubricant is supplied to the clutch chamber 30 via the orifice 39. By narrowing of the orifice 39, the secondary pressure of the secondary-pressure oil passage 32 increases and the feedback pressure of the feedback port 23c of the secondary regulator valve 23 also increases. Accordingly, the spool 23s moves against the spring 23b and the communication rate of the secondary-pressure port 23a and the back-pressure port 23e increases. In this state, of the defined source pressure from the back-pressure port 22f of the primary regulator valve 22, the proportion of oil flow supplied to the secondary-pressure oil passage 32 decreases, and the proportion of oil flow guided from the back-pressure port 23e to the lubricant passage 45 increases. In the state where the vehicle runs by complete engagement of the K0 clutch 6, the automatic transmission 2 is in a predetermined high-speed rotation state, the large amount of lubricant of the lubricant passage 45 is supplied to the lubrication portion 47 of the automatic transmission.

The secondary regulator valve 23 sticks in the illustrated state (fails to be turned on), the secondary pressure increases and the oil pressure supplied from the secondary-pressure oil passage 32 to the clutch lubricant passage 40 via the lubricant relay valve 25 also increases. In this state, the internal pressure of the clutch chamber 30 increases and there is a possibility that the drag torque of the K0 clutch 6 in the release state will increase. Accordingly, the relief valve 41 is disposed to be branched from the clutch lubricant passage 40. As a result, when the oil pressure of the lubricant passage 40 and therefore the oil pressure of the clutch chamber 30 increases by a predetermined value or more as described above, the relief valve 41 is released to prevent an increase in oil pressure by the predetermined value or more.

The solenoid valve 35 which is turned on to correspond to the slip control of the K0 clutch 6 and which is turned off in the other states (release and complete engagement) is controlled by the signal from the vehicle control device 10 on the basis of the input shaft rotation speed sensor 12 and the engine output shaft rotation speed sensor 11 or on the basis of a throttle opening sensor and the ON and OFF switch of a foot brake pedal.

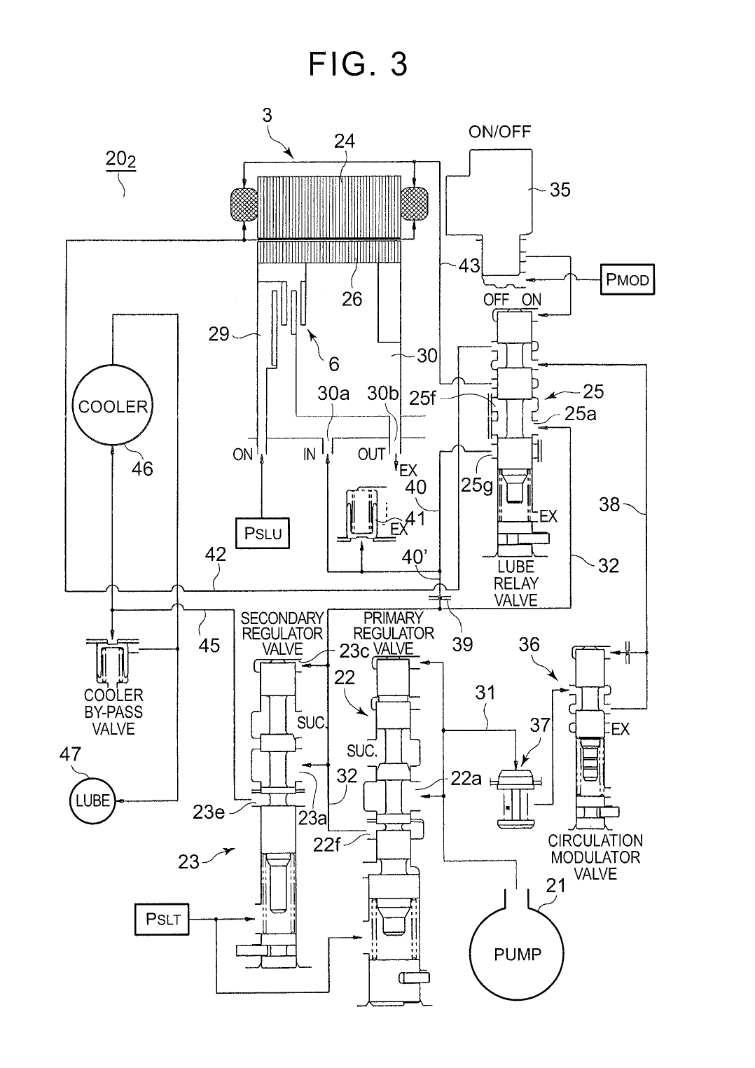

FIG. 3 illustrates an embodiment in which the position of the orifice 39 disposed in the clutch lubricant passage 40 is changed. That is, the hydraulic circuit 20₂ is provided with a communicating oil passage 40′ causing the secondary-pressure oil passage 32 and the clutch lubricant oil passage 40 to directly communicate with each other and the orifice 39 is disposed in the communicating oil passage 40′. Therefore, the second output port 25f of the lubricant relay valve 25 that is necessary in FIG. 2 is not necessary, and is closed.

In this embodiment, a small amount of oil reduced by the orifice 39 is supplied to the clutch lubricant passage 40 via the communicating oil passage 40′ from the secondary-pressure oil passage 32 regardless of the switching position of the lubricant relay valve 25.

In the states (release and complete engagement) other than the slip control state of the K0 clutch 6, the lubricant relay valve 25 is switched to the OFF position by the solenoid valve 35 and the secondary-pressure input port 25a is closed. In this state, a small amount of oil is directly supplied to the lubricant passage 40 from the secondary-pressure oil passage 32 via the orifice 39 to lubricate the K0 clutch 6. At this time, the oil pressure of the secondary-pressure oil passage 32 increases, the high pressure acts on the feedback port 23c, the communication rate between the secondary-pressure port 23a and the back-pressure port 23e increases, and a relatively large amount of oil is supplied to the lubricant passage 45 to lubricate the lubrication portion 47 of the automatic transmission.

In the state in which the K0 clutch 6 is slip-controlled, the lubricant relay valve 25 is switched to the ON position by the solenoid valve 35, the secondary-pressure input port 25a communicates with the first output port 25g, and the oil of the secondary-pressure oil passage 32 is directly supplied to the clutch lubricant passage 40 without passing through the orifice. In the state where the clutch chamber 30 is filled with the large amount of oil, the K0 clutch 6 in the slip control state is lubricated and cooled. At this time, the secondary-pressure oil passage 32 is in a low-pressure state close to the release state and the proportion of oil supplied from the back-pressure port 23e to the lubricant passage 45 through the use of the secondary regulator valve 23 significantly decreases.

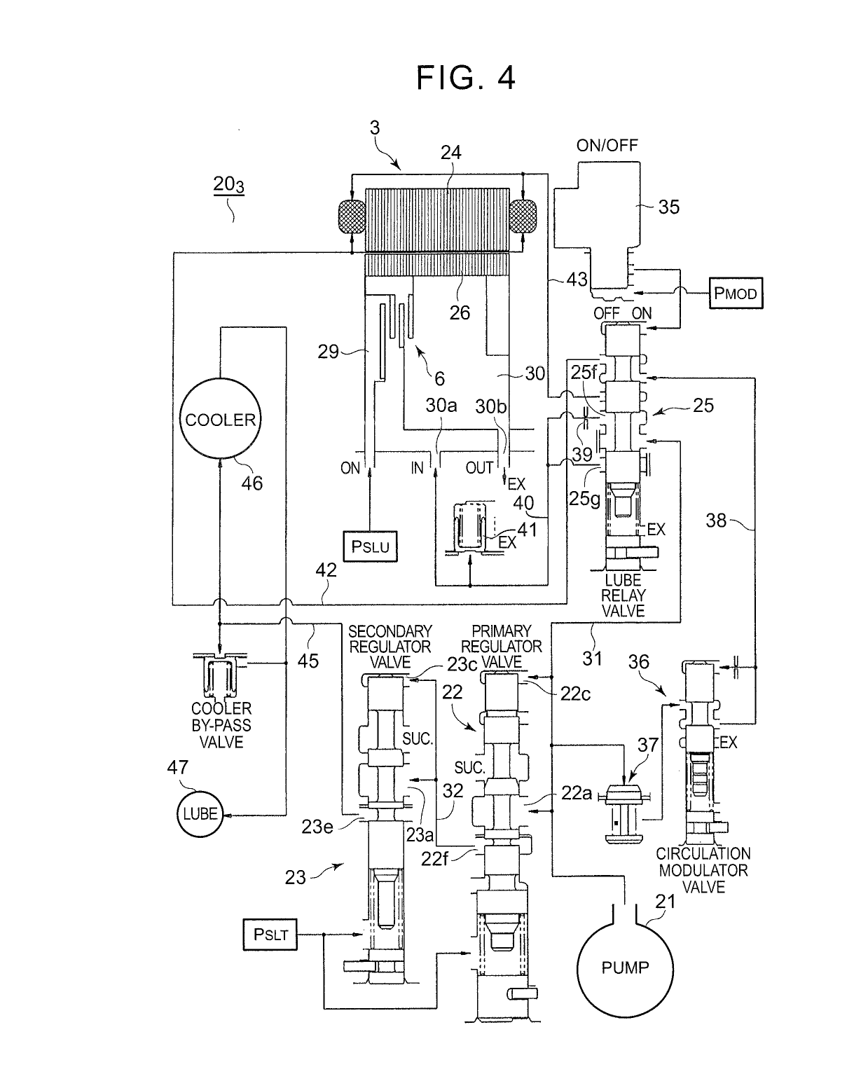

FIG. 4 illustrates an embodiment in which a line pressure is supplied as a source pressure of the input port 25a of the lubricant relay valve 25. In a hydraulic circuit 20₃, the line-pressure oil passage 31 communicating with the line-pressure port 22a of the primary regulator valve 22 communicates with the input port 25a of the lubricant relay valve 25.

When the K0 clutch 6 is in the release state or the complete engagement state, the lubricant relay valve 25 is switched to the illustrated OFF position by the solenoid valve 35. In this state, the line pressure regulated by the primary regulator valve 22 is supplied to the second output port 25f via the line-pressure oil passage (pressure-regulating oil passage) 31 and the input port 25a. A small amount of oil reduced by the orifice 39 is supplied to the K0 clutch 6 in the clutch chamber 30 via the clutch lubricant passage 40.

The oil pressure (line pressure) of the line-pressure oil passage 31 reduced by the orifice 39 increases and acts on the feedback port 22c to increase a communication rate between the line-pressure port 22a and the back-pressure port 22f. Accordingly, the back pressure (secondary pressure) from the back-pressure port 22f also increases and the feedback pressure acting on the feedback port 23c of the secondary regulator valve 23 also increases. Then, the communication rate between the secondary-pressure port 23a and the back-pressure port 23e of the valve increases and the amount of lubricant supplied form the back-pressure port to the lubricant passage 45 increases. That is, in the state where the K0 clutch 6 is in a non-slip state, the amount of lubricant of the K0 clutch decreases and the amount of lubricant supplied to the automatic transmission 2 accordingly increases.

In the state where the K0 clutch 6 is in the slip control state, the lubricant relay valve 25 is switched to the ON position by the solenoid valve 35. In this state, the line-pressure oil passage 31 directly communicates with the clutch lubricant passage 40 via the input port 25a and the first output port 25g, a large amount of oil from the line-pressure oil passage 31 is directly supplied to the clutch chamber 30, and the K0 clutch 6 is sufficiently lubricated and cooled.

In this state, the oil pressure of the line-pressure oil passage 31 accordingly decreases, the feedback pressure of the feedback port 22c of the primary regulator valve 22 decreases, the communication rate between the line-pressure port 22a and the back-pressure port 22f decreases, and the amount of oil supplied from the back-pressure port 22f to the secondary-pressure oil passage decreases. Accordingly, the feedback pressure of the feedback port 23c of the secondary regulator valve 23 decreases and the amount of oil guided from the back-pressure port 23e to the lubricant passage 45 also decreases. That is, in the slip control of the K0 clutch 6, the large portion of the defined amount of oil from the oil pump 21 is used to lubricate and cool the K0 clutch 6 and use thereof as the lubricant of the automatic transmission 2 is restricted.

In the embodiments described above, the present invention is applied to the hybrid vehicle driving system 1 and the vehicle starts with the internal combustion engine. However, the present invention is not limited to this configuration. The present invention may be similarly applied to the slip control of the K0 clutch 6 in the engine start at the time of start of the vehicle with the electric motor 3. The present invention is not limited to the hybrid vehicle driving system, and may be similarly applied to a driving system of a vehicle which has only an internal combustion engine as a drive source but includes a start clutch. The present invention may be similarly applied to an automatic transmission which includes a torque converter having a lockup clutch and which uses the lockup clutch as a start clutch.

### INDUSTRIAL APPLICABILITY

The present invention is applicable to a vehicle such as an automobile equipped with a driving system, particularly, a one-motor hybrid driving system.

### DESCRIPTION OF THE REFERENCE NUMERALS

1: (hybrid) vehicle driving system

2: automatic transmission

3: rotary electrical machine (electric motor)

5: engine

5a: engine output member (output shaft)

6: (disconnection, start) clutch

21: source pressure (oil pump)

22: (primary) regulator valve

22a: pressure-regulating (line-pressure) port

22c: feedback port

22f: back-pressure port

23: (secondary) regulator valve

23a: pressure-regulating (secondary-pressure) port

23c: feedback port

23e: back-pressure port

25: lubricant relay valve

25a: (pressure-regulating) input port

25b: modulator-pressure input port

25g: (first) output port

25f: second output port

25i: third output port

25h: fourth output port

26: rotor

30: clutch chamber

30a: in-port

30b: out-port

31: pressure-regulating (line-pressure) oil passage

32: pressure-regulating (secondary-pressure) oil passage

39: orifice

40: clutch lubricant passage

40′: communicating oil passage

42: axial center oil passage

43: direct oil passage

45: back-pressure (lubricant) oil passage

47: lubrication portion

1. A vehicle driving system in which a clutch is disposed between an engine output member and an automatic transmission and the clutch is used as a start clutch that is slip-controlled when a vehicle starts, the vehicle driving system comprising:
a regulator valve that has a pressure-regulating port and a feedback port communicating with a pressure-regulating oil passage from a source pressure and a back-pressure port communicating with a back-pressure oil passage and that adjusts a communication rate between the pressure-regulating port and the back-pressure port to regulate an oil pressure of the pressure-regulating oil passage;
a lubricant relay valve that has an input port and an output port communicating with the pressure-regulating oil passage and that switches the input port and the output port to a communicating position or a cutoff position; and
a clutch lubricant passage that communicates with the pressure-regulating oil passage via an orifice, that communicates with the output port, and that supplies lubricant to the clutch, wherein
when the lubricant relay valve is switched to the communicating position, oil from the pressure-regulating oil passage is supplied to the clutch via the input port, the output port, and the clutch lubricant passage, a feedback pressure of the feedback port is decreased, the communication rate between the pressure-regulating port and the back-pressure port is decreased, and an amount of lubricant supplied from the back-pressure oil passage to a lubrication portion of the automatic transmission is decreased, and
when the lubricant relay valve is switched to the cutoff position, the oil from the pressure-regulating oil passage is supplied to the clutch via the orifice and the clutch lubricant passage, the feedback pressure of the feedback port is increased, the communication rate between the pressure-regulating port and the back-pressure port is increased, and the amount of lubricant supplied from the back-pressure oil passage to the lubrication portion of the automatic transmission is increased.

2. The vehicle driving system according to claim 1, wherein the regulator valve is a secondary regulator valve, wherein
the pressure-regulating oil passage is a secondary-pressure oil passage communicating with a secondary-pressure port which is a pressure-regulating port of the secondary regulator valve, and
the back-pressure oil passage is a lubricant passage extending from the back-pressure port of the secondary regulator valve.

3. The vehicle driving system according to claim 1, wherein the lubricant relay valve includes a second output port in addition to a first output port which is the output port, and
the second output port communicates with the clutch lubricant passage via the orifice.

4. The vehicle driving system according to claim 1, further comprising a communicating oil passage causing the pressure-regulating oil passage and the clutch lubricant passage to directly communicate with each other, wherein
the orifice is provided in the communicating oil passage.

5. The vehicle driving system according to claim 1, further comprising a relief valve that is branched from the clutch lubricant passage and that releases a predetermined high pressure.

6. The vehicle driving system according to claim 1, wherein
the clutch is formed of a multi-disc wet clutch accommodated in a clutch chamber,
lubricant from the clutch lubricant passage is supplied to the clutch chamber via an in-port and the lubricant is discharged via an out-port, and
an amount of oil discharged from the out-port is smaller than an amount of oil directly supplied via the output port of the lubricant relay valve and is larger than an amount of oil supplied via the orifice.

7. The vehicle driving system according to claim 1, further comprising a rotary electrical machine, wherein
a rotor of the rotary electrical machine is connected to an input member of the automatic transmission and the vehicle driving system is a hybrid vehicle driving system, and
the clutch is a disconnection clutch that connects or disconnects the rotor of the rotary electrical machine and the engine output member.

8. The vehicle driving system according to claim 7, wherein the lubricant relay valve includes a modulator-pressure input port supplied with a modulator pressure obtained by decreasing the source pressure to a predetermined pressure, a third output port from which lubricant is directly supplied to the rotary electrical machine, and a fourth output port that communicates with the rotary electrical machine via an axial center oil passage of the automatic transmission, and
the modulator-pressure input port communicates with the third output port when the lubricant relay valve is switched to the communicating position, and communicates with the fourth output port when the lubricant relay valve is switched to the cutoff position.
